(19) United States
(12) Patent Application Publication
(10) Pub. No.: US 2002/0099852 A1
(43) Pub. Date: Jul. 25, 2002

(54) Mapping and caching of uniform resource locators for surrogate Web server

(76) Inventor: Herman Fischer, Woodland Hills, CA (US)

Correspondence Address: David A. Hall, Heller Ehrman White & McAuliffe LLP, 7th Floor, 4350 La Jolla Village Drive, San Diego, CA, 92122-1246, US

(21) Appl. No.: 10/037,618

(22) Filed: Jan. 2, 2002

Related U.S. Application Data
(60) Provisional application No. 60/259,495, filed on Jan. 3, 2001.

(51) Int. Cl. G06F 15/16

(52) U.S. Cl. 709/246; 709/218

(57) ABSTRACT

A content transformer transforms network content, such as Web pages, so that the content can be displayed on any type of user device. The content transformer functions as surrogate server between any network content server and the user device, so that all content that is received by the user device first passes through the content transformer. During the transformation of content, the content transformer replaces one or more original links on the Web page with corresponding surrogate links. The surrogate link contains an identifier code in place of a resource locator contained in the original link. The content transformer acts as an intermediary for all resource requests that originate from the user device and uses the identifier code to identify the resource locator that was originally associated with the replaced link. The identifier code preferably requires less memory and bandwidth space than the original URL, which is often a long and complex character string.

### REFERENCE TO RELATED APPLICATIONS

This application claims the benefit of priority from U.S. Provisional Application Ser. No. 60/259,495, entitled “Mapping and Caching of Uniform Resource Locators for Surrogate Web Server,” filed Jan. 3, 2001, which is incorporated herein by reference.

### BACKGROUND OF THE INVENTION

1. Field of the Invention

The present invention relates to accessing of resources in a computer network and, more particularly, relates to downloading of resources over the Internet using hyperlinks.

2. Description of the Related Art

The Internet and World Wide Web (“Web”), comprised of a vast array of international computer networks, may provide online service users with considerable information resources and other content. Typically, this content is accessed using a web browser, such as Microsoft Internet Explorer or Netscape Navigator, that is capable of understanding the HyperText Markup Language (HTML) used to create the documents found on the Web and the HyperText Transfer Protocol (HTTP) used to navigate the Web. The browser resides in memory on a Web-enabled device.

The browser issues HTTP messages to request Web pages, which are typically HTML documents that are located on the Internet. A requested Web page is typically identified using a link that references a uniform resource locator (“URL”), which is an address to a resource available on a computer network such as the Internet. A URL is comprised of a character string that may have a number of parts. These parts typically include at least a top level domain name, second level domain name, directory name, and file name. URLs may be used to identify the location of any type of file located on a web server. URLs may also point to other resources on the network such as database queries, command outputs, graphics, video, audio, or any other accessible resource. The character string associated with a URL may be rather lengthy so that the URL link consumes a large amount of communication bandwidth when embedded in a document that is transmitted over a computer network. Moreover, the URL link can consume a large amount of memory space if a copy of the document is stored locally on a Web-enabled device. This can create problems for certain Web-enabled devices, such as wireless devices, where communication bandwidth, memory and display space are limited. Additionally, the URL may not be in correct format for acceptance by certain Web-enabled devices that are equipped with microbrowsers. The problem is exacerbated for downloading of Web pages, which can contain a multitude of URL links, each of which contributes to the overall data size of the Web page.

In view of the foregoing, there is a need for a system and method that can convert URL links into a format that is suited for Web-enabled devices that have limited memory and communication bandwidth capabilities.

### SUMMARY OF THE INVENTION

The aforementioned needs are satisfied by the system and method disclosed herein. A content transformer transforms network content, such as Web pages, so that the content can be displayed on any type of user device that is communicatively coupled to a computer network. The content transformer functions as surrogate server between any network content server and the user device, so that all content that is received by the user device first passes through the content transformer.

During the transformation of content, the content transformer replaces one or more original links on the Web page with corresponding surrogate links. The surrogate link contains an identifier code in place of a resource locator contained in the original link. The content transformer acts as an intermediary for all resource requests that originate from the user device and uses the identifier code to identify the resource locator that was originally associated with the replaced link. The identifier code preferably requires less memory and bandwidth space than the original URL, which is often a long and complex character string. This is particularly advantageous where the user device is a wireless device, which may have limited capabilities in communication bandwidth and available memory. Additionally, the surrogate link is in a format that can be interpreted by the user device.

Other features and advantages of the present invention should be apparent from the following description of the preferred embodiment, which illustrates, by way of example, the principles of the invention.

### BRIEF DESCRIPTION OF THE DRAWINGS

FIG. 1 is an architectural representation of a computer network system that implements the content transformation described herein.

FIG. 2 is a representation of Web content comprised of an exemplary Web page.

FIG. 3 is a schematic representation of a communication path that the content follows in the course of being transmitted from a content server to a user device.

FIG. 4 is a flow diagram that illustrates the general operations involved in the transfer and transformation of content from the content server to the user device.

FIG. 5 is a schematic illustration of an original Web page and a transformed Web page.

FIG. 6 is a flow diagram that describes the processing steps performed to replace original links in Web pages with surrogate links.

FIG. 7 is an illustration of a URL mapping table configured in accordance with one aspect of the invention.

FIG. 8 is a flow diagram that describes the processing steps performed to process resource requests that contain surrogate links.

FIG. 9 is a block diagram of a computer device that is a node of the computer network of FIG. 1.

### DETAILED DESCRIPTION

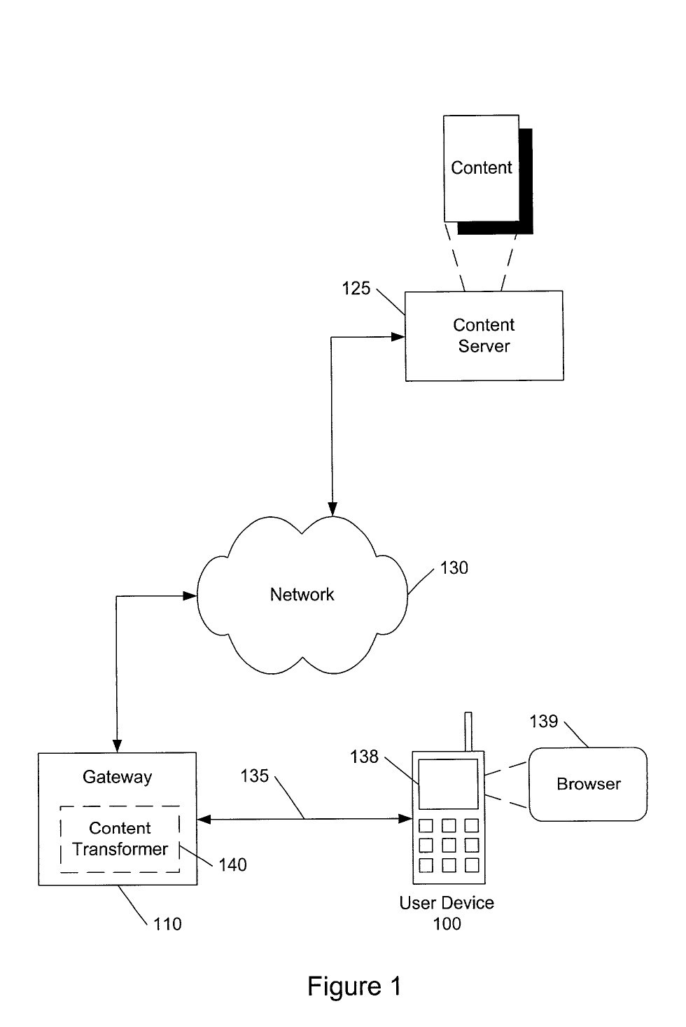

FIG. 1 shows the architecture of a computer network system comprised of a user device 100, a network gateway device 110, and a Web content server 125, which are nodes of a computer network. The network gateway device 110 and the content server 125 are communicatively linked via a computer network 130, such as the Internet. As used herein, the term “Internet” refers to a collection of interconnected (public and/or private) networks that are linked together by a set of standard protocols (such as TCP/IP and HTTP) to form a global, distributed network. While this term is intended to refer to what is now commonly known as the Internet, it is also intended to encompass variations which may be made in the future, including changes and additions to existing standard protocols. FIG. 1 shows only a single user device 100, a single server 125, and a single gateway device 1 10, although the computer network system could include a plurality of such devices.

As described in detail below, a content transformer 140 is configured to transform network content so that the content can be displayed on any type of user device 100. If the network 130 comprises the Internet, the user device 100 can advantageously browse any Web site on the Internet by way of the content transformer 140, which transforms Web content into a format suitable for the user device 100. The content transformer 140 preferably acts as a pass-through or surrogate server between any network content server and the user device 100, so that all content that is received by the user device 100 first passes through the content transformer 140. The content transformer 140 can reside anywhere in the communication path between the content server 125 and the user device 100, although the content transformer 140 is described herein as residing at the gateway device 110.

During the transformation of content, the content transformer 140 replaces one or more original links on the Web page with corresponding surrogate links. An original link contains a resource locator, which identifies the location of a resource on the computer network 130. The surrogate link contains an identifier code in place of the resource locator. The content transformer 140 acts as an intermediary for all resource requests that originate from the user device 100 and uses the identifier code to identify the resource locator that was originally associated with the replaced link. The identifier code preferably requires less memory and bandwidth space than the original URL, which is often a long and complex character string. This is particularly advantageous where the user device 100 is a wireless device, which may have limited capabilities in communication bandwidth and available memory.

With reference to FIG. 1, the user device 100 comprises any device that is configured to interact with the network 130. In one embodiment, the user device 100 comprises a mobile, hand-held device having an antenna that interacts with the network 130 through a wireless communication link 135 with the gateway device 110. The hand-held user device 100 is preferably of a size such that a human can hold and transport the user device 100 in his or her hand. Such devices include mobile phones and personal digital assistants and typically include a display screen having a size that is smaller than the display screens that are typically associated with personal computers. For example, a rectangular display screen 138 for the user device 100 may have a width and height that are both less than 5 inches.

A browser 139 preferably resides in the memory of the user device 100. The browser 139 is a software application that is used to request and display content from the network 130, such as World Wide Web pages. In the case of the user device 100 being a hand-held device, the browser 139 is preferably a microbrowser comprised of an Internet browser with a small file size that can accommodate the memory constraints of the user device 100 and the bandwidth constraints of the wireless communication link 135.

The gateway device 110 comprises a device, such as a computer, that functions as a communication entryway/exitway to/from the network 130 for the user device 100. The gateway device 110 provides the user device 100 with access to the network 130 such that any communication between the network 130 and the user device 100 travels through the gateway device 110. As mentioned, the user device 100 preferably communicates with the gateway device 110 via a wireless communication link 135. In this regard, the gateway device 110 preferably converts content received from the network 130 into a format suitable for transport over the wireless communication link 135.

The content server 125 comprises a computer system that stores content and serves the content over the network 130, such as using the standard protocols of the World Wide Web. The content server 125 is representative of any source of content available to the user device 100 via the network 130. The content server 125 is generally intended to encompass both the hardware and software server components that serve the content over the network 130. The content server 125 is not limited to comprising a single computer device, as the content server 125 could, for example, include multiple computer devices that are appropriately linked together.

As used herein, the term “content” refers to any type of electronic data that may be served by the content server 125 and transported over the network 130, including Web pages (also referred to herein as Web documents). The term “native format” is used herein to refer to the format in which the content is stored by the content server 125. The user device 100 may be unable to interpret and use content that is in a native format due, for example, to hardware capability restrictions of the user device 100 or software incompatibilities between the user device 100 and the content server 125. The term “user device format” is used to refer to content in a format that is suitable for interpretation and use by the user device 100.

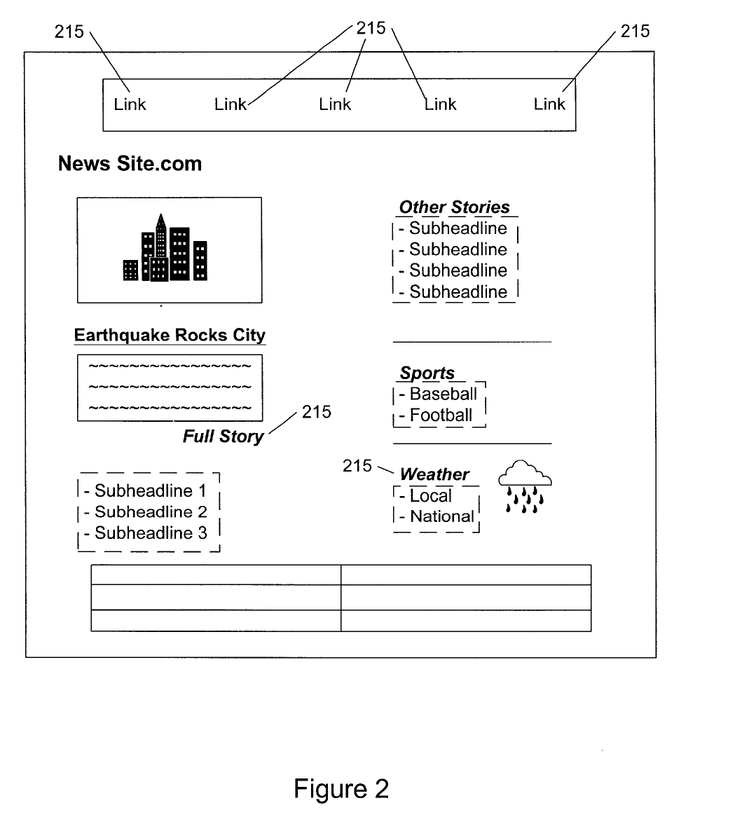

The content may comprise a Web page, which is comprised of a hyperlink document that is written in a descriptive markup language, such as the Hyper Text Markup Language (HTML) and that is available over the Internet. FIG. 2 shows an exemplary Web page 205 as it would normally be displayed on a window of a browser application, such as “Internet Explorer” from Microsoft Corporation or “Navigator” from Netscape Communications Corporation.

The Web page 205 is divided into several logical structures or elements, including headings, paragraphs, tables, lists, separators, graphics, tables, table items, etc. The Web page 205 includes at least one hyperlink 215, which is an element that links to a resource on the network 130, such as another place in the same Web page or to an entirely different Web page. The hyperlink could also link to any other resource, which can include a database query, command output, graphic, video file, audio file, frame, e-mail address, or any other accessible resource on the network 130. The particular resource that is linked to a hyperlink 215 is generally accessed by selecting and clicking on the hyperlink 215, such as by using a cursor. A hyperlink 215 may be displayed using any of a wide variety of formats, including using a text format or an image format.

As mentioned, the Web page 205 may be written in a descriptive markup language, such as HTML. The HTML code for the Web page 205 includes markup identifiers, or tags, that delimit the elements of the Web page, including one or more tags that identify the hyperlinks 215 in the Web page 205. In an HTML document, the anchor tag <A> is used to identify a hyperlink in combination with an “HREF=” attribute, which specifies the resource locator for the linked resource. The resource locator contains address information descriptive of the location of the resource on the network 130. The resource locator can also contain information regarding the format of the resource. In the case of the Internet, the resource locator can comprise a uniform resource locator (URL), as will be known to those of skill in the art.

With reference again to FIG. 1, the content transformer 140 is configured to transform content into a user device format that is suitable for interpretation and display on the user device 100. The content transformer 140 preferably transforms content according to a set of predefined rules, which may be defined generally or on a page-by-page and/or site-by-site basis, as described in more detail below. The content transformer 140 may comprise either the hardware or software components that perform the aforementioned content transformation, or both. In this regard, the content transformer 140 may comprise software that resides in the memory of the content server 125 and/or the gateway device 110. The content transformer 140 may also comprise a combination of software and hardware that is physically separate from the content server 125 and the gateway device 110.

Content Communication Path and General Transformation Process

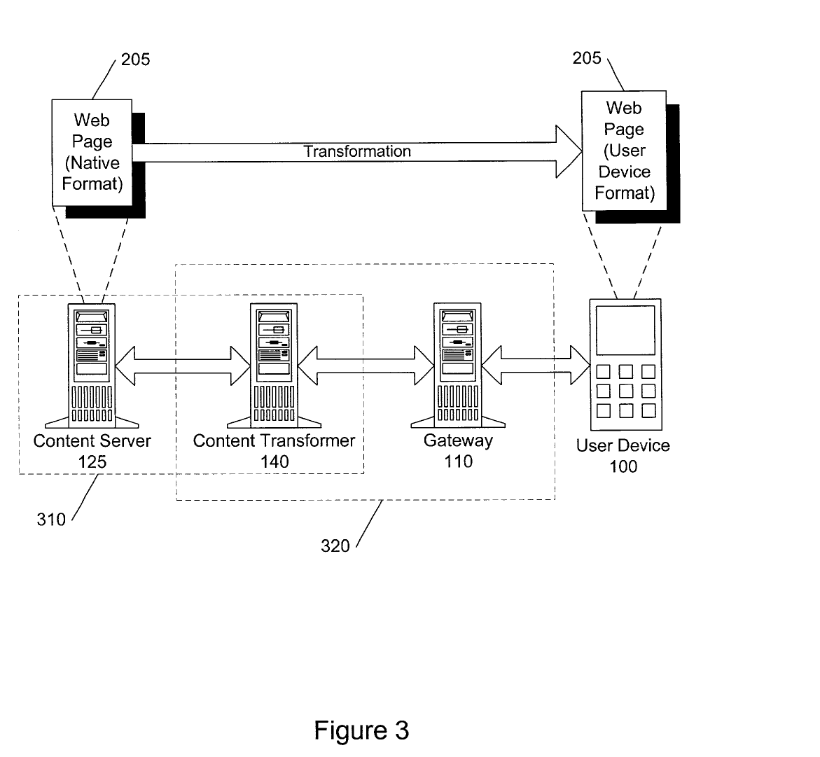

FIG. 3 schematically illustrates the communication path that content follows in the course of being transmitted from the content server 125 to the user device 100 according to one aspect of the invention. The content is described in the exemplary context of a Web page 205 that is stored and served by the content server 125. The communication path of the Web page 205 originates at the content server 125, where the Web page 205 is stored in a native format. The native format of the Web page 205 may comprise, for example, HTML code containing various HTML tags that define the Web page 205.

The communication path of the Web page 205 continues to the content transformer 140, where the Web page is transformed into a user device format. The transformation occurs wherever the content transformer 140 resides. The content transformer could reside at the content server 125 (as exhibited by the dashed box 310 in FIG. 3) or at the gateway device 110 (as exhibited by the dashed box 320 in FIG. 3). The content transformer 140 could also reside at a stand-alone site that communicates with the network 130. A separate instance of the content transformer 140 may also be located at each location, in which case the downstream (closest to content server 125) instance of the content transformer 140 would allow the upstream (closest to user device 100) instance of the content transformer 140 to retrieve respective rule sets for correct processing. This ensures that the content rules are correctly utilized in the transformation process. The content transformer 140 is described herein as residing at the gateway device 110.

From the gateway device 110, the communication path of the Web page 205 continues to the user device 100. As a result of the transformations, the Web page 205 is in a user device format when received by the user device 100. The user device 100 can then display the Web page 205 on its display screen.

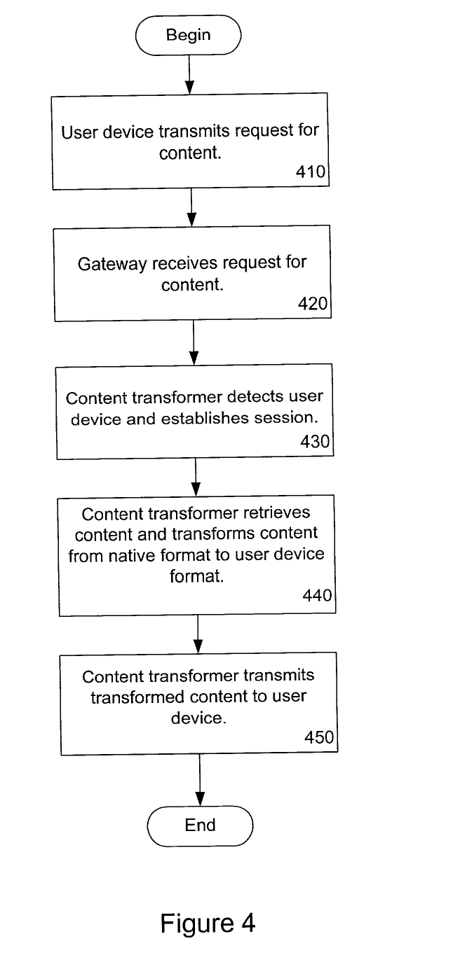

FIG. 4 is a flow chart that describes the general processes involved in the request, transfer, and transformation of content. In a first operation, represented by the flow diagram box numbered 410, the user device 100 transmits a request for content. The request includes a uniform resource locator (URL), which specifies the location of content on the network 130. In this example, the URL identifies the content server 125 as being the location of the content. The user device 100 can transmit the request, for example, by the user selecting a hyperlink on the display screen of the user device 100 or by the user manually entering a URL using alpha-numeric keys on the user device 100.

The gateway device 110 then receives the request for content from the user device 100, as represented by the flow diagram box numbered 420. The content transformer 140, which resides at the gateway device 110, detects the user device 100 and establishes a session for the user device 100. This is represented by the flow diagram box numbered 430.

In the next operation, the content transformer 140 retrieves the requested content, which may be, for example, a Web page document written in HTML, and transforms the content from a native format into a user device format, as represented by the flow diagram box numbered 440. As mentioned, the content transformation occurs wherever the content transformer 140 resides, which in the current example is at the gateway device 110. The content transformer 140 transforms the content into a format that is optimized for display on the user device 100. The content transformer 140 preferably accesses a set of rules that govern the transformation and conducts a semantic and structural analysis of the content according to the processes described in co-pending U.S. patent application Ser. No. 09/886,299 entitled “ADAPTIVE PROFILE-BASED MOBILE DOCUMENT INTEGRATION,” which is incorporated herein by reference and is assigned to the assignee of the present application.

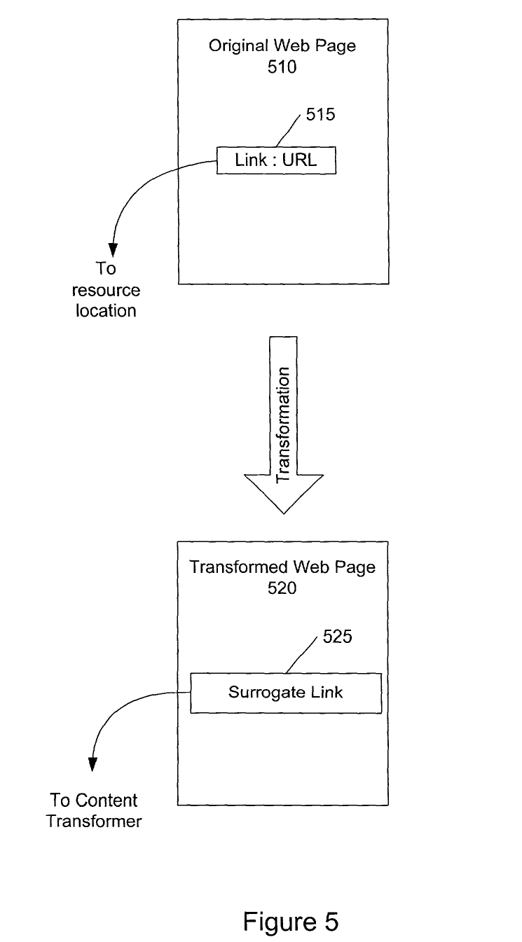

During the content transformation process, the content transformer 140 replaces links in the content with surrogate links. This is generally described with reference to FIG. 5, which shows an original Web page 510 that includes at least one link 515 that is associated with a URL. The link 515 points to a resource location or address of the resource associated with the URL. If the Web page 510 were displayed on a computer device and a user selected the link 515, the computer device would attempt to establish a connection with the location specified in the URL order to retrieve the resource associated with the URL.

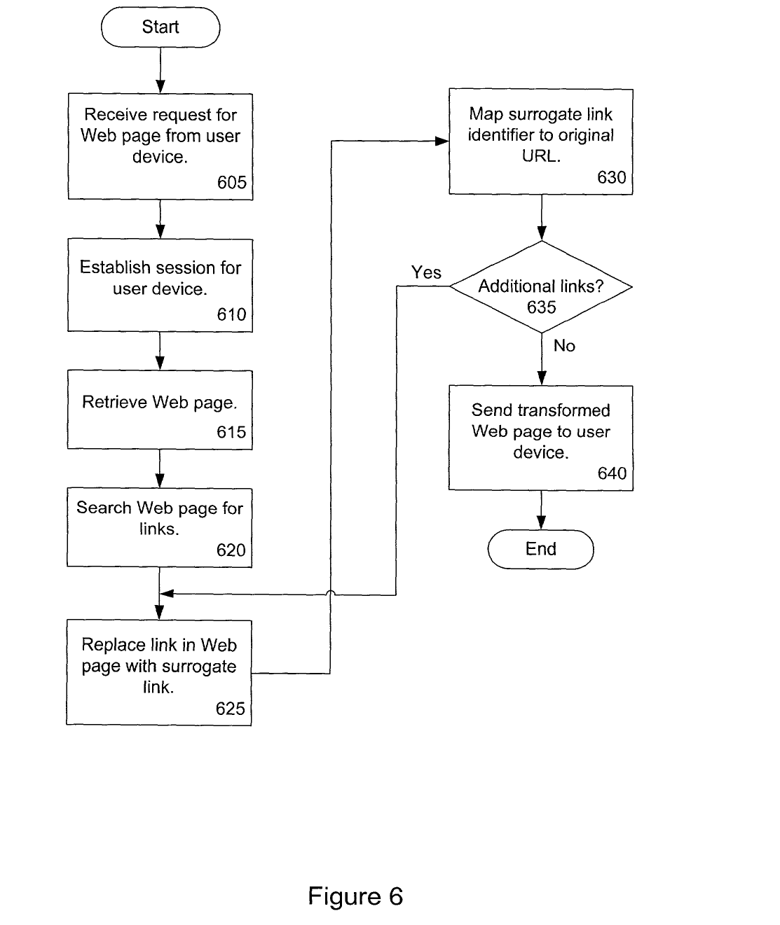

The content transformer 140 transforms the Web page 510 to replace the links 515 with a surrogate link 525 that points to a new location specified by the content transformer 140 rather than to the actual location that is associated with the URL. The new location is preferably the location of the content transformer 140. Thus, if the transformed Web page 520 were displayed on a computer device and a user selected the surrogate link 525, the computer device would attempt to establish a connection with the content transformer 140 rather than with the original resource location specified in the URL. This process is described in more detail below with respect to FIG. 6.

With reference again to FIG. 4, after transformation of the content, the content transformer 140 transmits the transformed content to the user device 100 for display. This is represented by the flow diagram box numbered 450.

Transformation of Links in Content

FIG. 6 is a general flow diagram that describes the processing steps performed by the content transformer 140 in replacing original links in content with surrogate links. In the first operation, represented by the flow diagram box numbered 605, the content transformer 140 (via the gateway device 110) receives a request from the user device 100 for content, which is described herein as being a Web page. The request typically includes a URL that specifies the location of the Web page on the network 130. The content transformer 140 then establishes a session for the user device 100, as represented by the flow diagram box numbered 610.

In the next operation, represented by the flow diagram box numbered 615, the content transformer 140 retrieves the requested Web page in a well known manner. The content transformer 140 typically establishes a connection with a server device that serves the requested Web page and then receives a copy of the Web page over the network 130 from the server device.

In the next operation, represented by the flow diagram box numbered 620, the surrogate server 120 examines the Web page 210 to determine if the Web page contains any links to resources, such as hyperlinks that specify the location of a resource on the network 130. This may be accomplished by searching the code in which the Web page is written for tags that identify links. If the Web page is written in HTML, then the content transformer 140 searches the code for <A> tags that identify links. The “HREF” attribute of such a tag is used to identify the corresponding URL. For example, a Web page that contains the code “<A HREF=“http://www.mobilewebsurf.com”> is a link that points to the location www.mobilewebsurf.com, which is accessed according to HTTP. The content transformer 140 may parse the Web page in order to identify link elements using readily available software, such as openXML Parser. The content transformer 140 can also search for other tags or code not recited herein that identify links in the content.

When a link is identified, the content transformer 140 replaces the link in the Web page with a surrogate link, as represented by the flow diagram box numbered 625. The surrogate link preferably points to the location of the content transformer 140 and contains an identifier code in place of the URL that was originally associated with the link. The identifier code can comprise an alphanumeric string that contains less characters than the original URL, so that the identifier code consumes less memory space and less bandwidth space than the original URL. For example, if the Web page contains code that identifies the link <A HREF=“http://www.mobilewebsurf.com”>, the content transformer replace the code with the surrogate link <A HREF=“1”>, where “1” is the identifier code for that surrogate link. The content transformer 140 later uses the identifier code to map the surrogate link to the original URL, as described in more detail below.

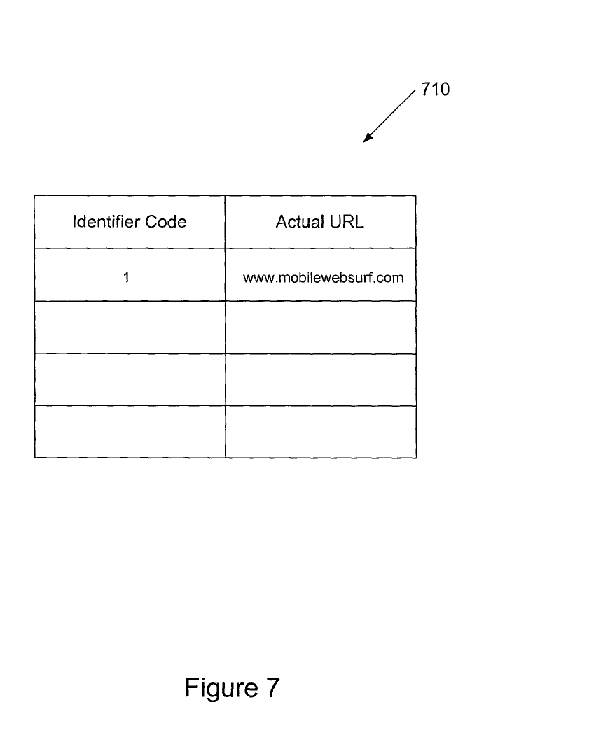

In the next operation, represented by the flow diagram box numbered 630, the content transformer 140 maps the identifier in the surrogate link to the URL that was originally associated with the link. The content transformer 140 can maintain a table that contains an entry for each surrogate link identifier code and the corresponding URL for the identifier code. FIG. 7 shows a mapping table 710 that is maintained in memory local to the content transformer 140. The mapping table 710 includes one or more entries, with each entry containing a surrogate link identifier code and an associated URL. The table entries can be indexed according to the identifier codes. The identifier code could comprise an ordinal position in the table 710. The table 710 is shown containing a first identifier code “1” and the associated URL,“www.mobilewebsurf.com.” The content transformer 140 preferably maintains a table 710 for each session so that each session has a unique table 710 associated therewith. The table 710 could also take on other formats, such as a single column format where the row number is used as an index for the identifier code. The table 710 entries could also include additional columns for storage of additional data.

With reference again to FIG. 6, the content transformer 140 next determines whether there are any additional links in the Web page, as represented by the decision box numbered 635. The content transformer repeats the operations shown in the flow diagram boxes 625 and 630 for each link in the Web page, as represented by the “Yes” outcome to the decision box numbered 635.

When there are not any additional links to be replaced, a “No” outcome will result at the decision operation represented by the decision box numbered 635. The content transformer 140 then proceeds to the next operation shown in the flow diagram box numbered 640, where the content transformer transmits the transformed Web page to the user device 100. The transformed Web page includes surrogate links in place of the original links. It is appreciated that the content transformer 140 could also perform other transformations to the Web page which are not described herein in order to put the Web page in a format that is suited for the user device 100. The user device is thereby provided with a transformed Web page in which all links in the original Web page are replaced with surrogate links.

Processing of Requests Containing Surrogate Links

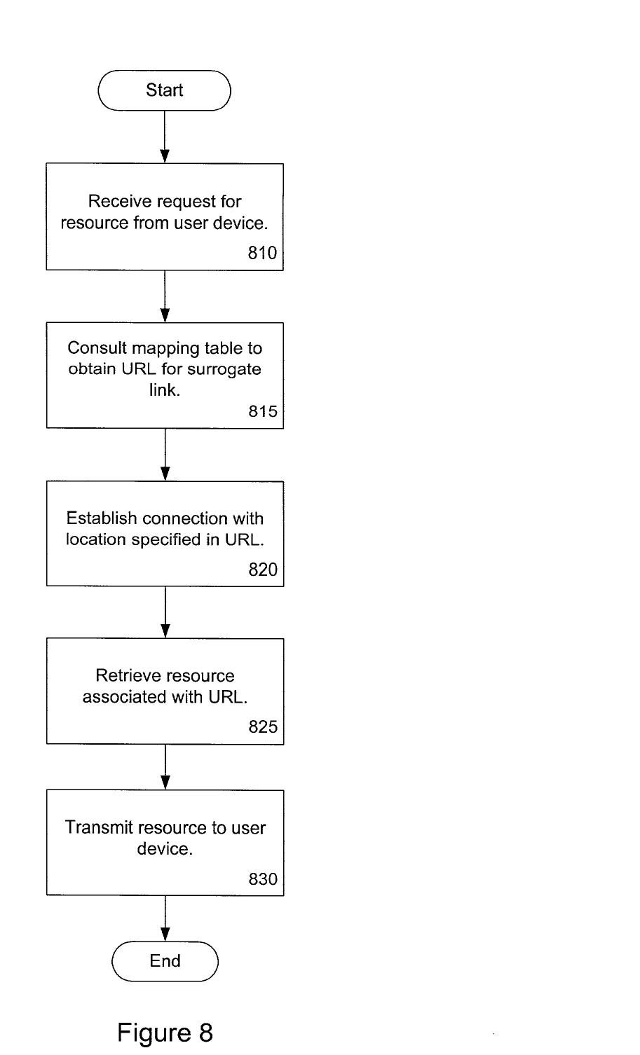

FIG. 8 shows a flow diagram that describes the operations by which the content transformer 140 processes requests from the user device 100 to obtain a resource associated with a surrogate link. The content transformer 140 receives such requests when a person selects a surrogate link on a transformed Web page. In the first operation, represented by the flow diagram box numbered 810, the content transformer 140 receives a request from the user device 100 to obtain a resource associated with a surrogate link. The request includes an embedded identifier code that is associated with the surrogate link.

In the next operation, represented by the flow diagram box numbered 815, the surrogate server 120 consults the URL mapping table 710 (FIG. 7) to obtain the URL that is associated with the surrogate link. The content transformer 140 reads the identifier code that is embedded in the request from the user device 100. The content transformer 140 then obtains the corresponding URL for the identifier code from the mapping table 710 that is associated with the user device session. The URL from the mapping table is the URL that was originally associated with the link before it was transformed to a surrogate link.

The content transformer 140 then establishes a logical connection with the location on the network that is specified in the URL, as shown in the flow diagram box numbered 820. For example, if the URL is associated with a graphic that is located at the content server 125 (FIG. 1), then the content transformer 140 establishes a connection with the content server 125 over the network 130.

In the next operation, the content transformer 140 retrieves the resource that is associated with the URL, as represented by the flow diagram box numbered 825. The content transformer 140 then transmit the resource to the user device 100, as represented by the flow diagram box numbered 830. Prior to transmitting the resource, the content transformer 140 preferably transforms the resource (if necessary) in order to place it in a format that is usable by the user device 100. Advantageously, the surrogate links permit the content transformer 140 to intercept resource requests that originate from the user device 100 and transform any resource that is requested by the user device 100. The surrogate links also consume less bandwidth and memory space than the original links, which often contain long and complex URLs.

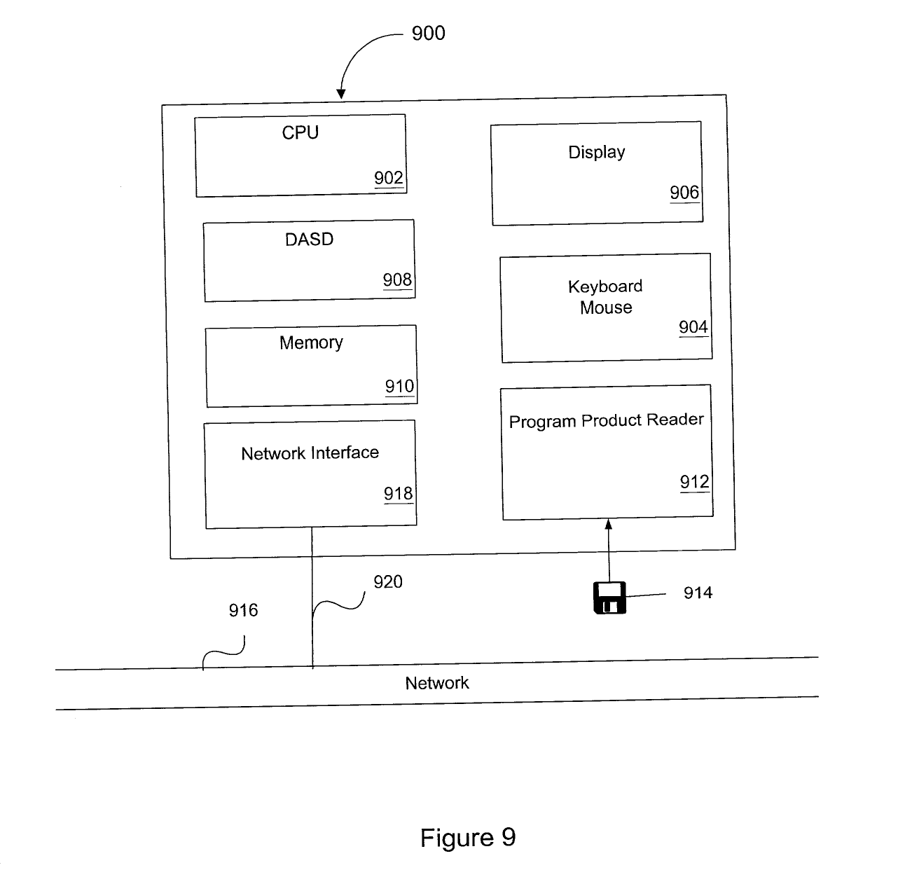

FIG. 9 is a block diagram of an exemplary computer 900 such as might comprise any of the nodes of the computer network 130, including the gateway device 110 or the content server 125. The computer 900 operates under control of a central processor unit (CPU) 902, such as a “Pentium” microprocessor and associated integrated circuit chips, available from Intel Corporation of Santa Clara, Calif., U.S.A. A computer user can input commands and data from a keyboard and computer mouse 904, and can view inputs and computer output at a display 906. The display is typically a video monitor or flat panel display. The computer 900 also includes a direct access storage device (DASD) 908, such as a hard disk drive. The memory 910 typically comprises volatile semiconductor random access memory (RAM).

The computer preferably includes a program product reader 912 that accepts a program product storage device 914, from which the program product reader can read data (and to which it can optionally write data). The program product reader can comprise, for example, a disk drive, and the program product storage device can comprise removable storage media such as a magnetic floppy disk, a CD-R disc, a CD-RW disc, or DVD disc.

The computer 900 can communicate over a computer network 916 (such as the Internet or an intranet) through a network interface 918 that enables communication over a connection 920 between the network 916 and the computer. The network interface 918 typically comprises, for example, a Network interface Card (NIC) that permits communications over a variety of networks.

The CPU 902 operates under control of programming steps that are temporarily stored in the memory 910 of the computer 900. When the programming steps are executed, the computer performs its functions. Thus, the programming steps implement the functionality of the content transformer 140. The programming steps can be received from the DASD 908, through the program product storage device 914, or through the network connection 920. The program product storage drive 912 can receive a program product 914, read programming steps recorded thereon, and transfer the programming steps into the memory 910 for execution by the CPU 902. As noted above, the program product storage device can comprise any one of multiple removable media having recorded computer-readable instructions, including magnetic floppy disks and CD-ROM storage discs. Other suitable program product storage devices can include magnetic tape and semiconductor memory chips. In this way, the processing steps necessary for operation in accordance with the invention can be embodied on a program product.

Alternatively, the program steps can be received into the operating memory 910 over the network 916. In the network method, the computer receives data including program steps into the memory 910 through the network interface 918 after network communication has been established over the network connection 920 by well-known methods that will be understood by those skilled in the art without further explanation. The program steps are then executed by the CPU. Any of the nodes of the computer network can have an alternative construction, so long as it can support the functionality described herein. For example, the user device 100 may comprise a mobile device that has an antenna and at least some of the components of the computer 900.

Although this invention has been described in terms of certain preferred embodiments, other embodiments that are apparent to those of ordinary skill in the art are also within the scope of this invention. Accordingly, the scope of the present invention is intended to be defined only by reference to the appended claims.

We claim:

1. A method of transforming a Web page, comprising:
receiving a copy of the Web page;
examining the contents of the Web page to identify an original link that contains a resource locator that specifies a location of a resource on a computer network;
replacing the original link in the Web page with a surrogate link that contains an identifier code associated with the resource locator to thereby generate a transformed Web page;
maintaining a map that relates the identifier code to the associated resource locator.

2. A method as defined in claim 1, additionally comprising:
sending a copy of the transformed Web page containing the surrogate link to a user device that requested the Web page.

3. A method as defined in claim 1, wherein maintaining a map that relates the identifier code to the associated resource locator comprises maintaining a mapping table that has one or more entries, wherein each entry contains a resource locator associated with an identifier code, the entries being indexed according to associated identifier codes.

4. A method as defined in claim 3, additionally comprising:
establishing a session with a user device, wherein the table is associated with the session.

5. A method as defined in claim 1, wherein the Web page is written in HyperText Markup Language (HTML), and wherein the original links are identified by an HTML tag.

6. A method as defined in claim 1, wherein the resource locator is a uniformn resource locator that specifies an Internet address of a resource located on the Internet.

7. A method as define in claim 1, wherein the surrogate link specifies a resource location different than the location specified in the resource locator.

8. A method as defined in claim 1, wherein the identifier code and the resource locator are alphanumeric strings and the identifier code alphanumeric string is smaller than the resource locator alphanumeric string.

9. A method of accessing a resource located on a computer network, comprising:
receiving a request for a resource from a user device, the request including an identifier code associated with a resource locator that identifies the location of a resource on the computer network;
using the identifier code to identify the resource locator that is associated with the identifier code;
submitting a request for the resource associated with the uniform resource locator, wherein the request is submitted to an address specified in the uniform resource locator.

10. A method as defined in claim 9, wherein using the identifier code to identify the resource locator that is associated with the identifier code comprises consulting a mapping table that contains one or more entries, each entry containing an identifier code and a resource locator associated with the identifier code.

11. A method as defined in claim 10, wherein the mapping table is indexed according to the identifier codes in entries of the mapping table.

12. A method as defined in claim 9, additionally comprising:
receiving a copy of a Web page;
examining the contents of the Web page to identify an original link that contains a resource locator that specifies a location of a resource on a computer network;
replacing the original link in the Web page with a surrogate link that contains an identifier code associated with the resource locator to thereby generate a transformed Web page;
maintaining a map that relates the identifier code to the associated resource locator.

13. A system that transforms a Web page located on a computer network, the system comprising:
content processor means for executing program instructions and receiving a data set; and
a network interface that permits communications between the content processor means and the computer network;
wherein the program instructions executed by the content processor means comprise
receiving a copy of the Web page,
examining the contents of the Web page to identify an original link that contains a resource locator that specifies a location of a resource on a computer network,
replacing the original link in the Web page with a surrogate link that contains an identifier code associated with the resource locator to thereby generate a transformed Web page, and
maintaining a map that relates the identifier code to the associated resource locator.

14. A system as defined in claim 13, wherein the program instructions executed by the content processor means further comprise program instructions to:
send a copy of the transformed Web page containing the surrogate link to a user device that requested the Web page.

15. A system as defined in claim 13, wherein the Web page is written in HyperText Markup Language (HTML), and wherein the original links are identified by an HTML tag.

16. A system that accesses a resource located on a computer network, the system comprising one or more processors that execute program instructions and receive a data set, and:
receives a request for a resource from a user device, the request including an identifier code associated with a resource locator that identifies the location of a resource on the computer network;
uses the identifier code to identify the resource locator that is associated with the identifier code;
submits a request for the resource associated with the uniform resource locator, wherein the request is submitted to an address specified in the uniform resource locator.

17. A system as defined in claim 15, wherein using the identifier code to identify the resource locator that is associated with the identifier code comprises consulting a mapping table that contains one or more entries, each entry containing an identifier code and a resource locator associated with the identifier code.

18. A system as defined in claim 15, wherein the processors further execute program instructions to:
receive a copy of a Web page;
examine the contents of the Web page to identify an original link that contains a resource locator that specifies a location of a resource on a computer network;
replace the original link in the Web page with a surrogate link that contains an identifier code associated with the resource locator to thereby generate a transformed Web page;
maintain a map that relates the identifier code to the associated resource locator.

19. A program product for use in a computer system that executes program steps recorded in a computer-readable media to perform a method for transforming a Web page, the program product comprising:
a recordable media;
a program of computer-readable instructions executable by the computer system to perform operations comprising:
receiving a copy of the Web page;
examining the contents of the Web page to identify an original link that contains a resource locator that specifies a location of a resource on a computer network;
replacing the original link in the Web page with a surrogate link that contains an identifier code associated with the resource locator to thereby generate a transformed Web page;
maintaining a map that relates the identifier code to the associated resource locator.

20. A program product as defined in claim 19, wherein program of computer-readable instructions executable by the computer system to perform operations further comprising:
sending a copy of the transformed Web page containing the surrogate link to a user device that requested the Web page.

21. A program product as defined in claim 19, wherein maintaining a map that relates the identifier code to the associated resource locator comprises maintaining a mapping table that has one or more entries, wherein each entry contains a resource locator associated with an identifier code, the entries being indexed according to associated identifier codes.

22. A program product for use in a computer system that executes program steps recorded in a computer-readable media to perform a method for transforming a Web page, the program product comprising:
receiving a request for a resource from a user device, the request including an identifier code associated with a resource locator that identifies the location of a resource on the computer network;
using the identifier code to identify the resource locator that is associated with the identifier code;
submitting a request for the resource associated with the uniform resource locator, wherein the request is submitted to an address specified in the uniform resource locator.

23. A program product as defined in claim 22, wherein program of computer-readable instructions executable by the computer system to perform operations further comprising:
receiving a copy of a Web page;
examining the contents of the Web page to identify an original link that contains a resource locator that specifies a location of a resource on a computer network;
replacing the original link in the Web page with a surrogate link that contains an identifier code associated with the resource locator to thereby generate a transformed Web page;
maintaining a map that relates the identifier code to the associated resource locator.

24. A method of transforming a Web document, comprising:
receiving a Web document;
examining the Web document for a uniform resource locator;
replacing a uniform resource locator in the document with an address that points to a surrogate server;
associating the uniform resource locator with an identifier code;
maintaining a table that maps the identifier code associated with the uniform resource locator to the uniform resource locator.

25. A method of accessing a resource on the Internet, comprising:
receiving a request for a resource from a user device, the request including an identifier code associated with a uniform resource locator;
consulting a table that maps the identifier code to a uniform resource locator;
identifying the uniform resource locator associated with the identifier code;
submitting a request for the resource associated with the uniform resource locator, wherein the request is submitted to an address specified in the uniform resource locator.
